(19) United States
(12) Patent Application Publication
(10) Pub. No.: US 2013/0034329 A1
(43) Pub. Date: Feb. 7, 2013

(54) MODULAR OPTICAL ASSEMBLY

(71) Applicants: James L. Tucker, Clearwater, FL (US); Cornelius R. Clawser, Pinellas Park, FL (US); Sandra Driesse-Bunn, Clearwater, FL (US); Steven J. Sanders, Scottsdale, AZ (US)

(72) Inventors: James L. Tucker, Clearwater, FL (US); Cornelius R. Clawser, Pinellas Park, FL (US); Sandra Driesse-Bunn, Clearwater, FL (US); Steven J. Sanders, Scottsdale, AZ (US)

(73) Assignee: HONEYWELL INTERNATIONAL INC., Morristown, NJ (US)

(21) Appl. No.: 13/197,963

(22) Filed: Aug. 4, 2011

(51) Int. Cl. G02B 6/36; B23P 11/00

(52) U.S. Cl. 385/94; 385/92; 29/428

(57) ABSTRACT

An assembly includes an optical device including an optical component and a plurality of supporting electrical components, a housing that is configured to house the optical component, a cap that is configured to substantially enclose the optical component in the housing, and a mounting member that is configured to removably electrically and mechanically connect the optical component to a printed board. In some examples, the housing does not house any electrical components of the optical device. The housing is physically separate from the mounting member and is configured to removably mechanically connect to the mounting member. The housing and mounting member define an electrically conductive pathway from the optical component to the printed board. When the cap is mechanically disconnected from the housing, the optical component may be exposed. The cap may also be configured to mechanically and optically connect an optical fiber assembly to the optical component.

### STATEMENT REGARDING FEDERALLY SPONSORED RESEARCH OR DEVELOPMENT

This invention was made with Government support under Government Contract #FA8650-04-C-8011 awarded by the Air Force. The Government has certain rights in the invention.

### TECHNICAL FIELD

The disclosure relates to an optical assembly including an optical device.

### BACKGROUND

An optical assembly may include an optical device mounted on a printed board and an optical fiber optically connected to the optical device. The optical device may include an optical component, such as, for example, at least one of a light emitting diode or a light receiving diode.

### SUMMARY

In general, the disclosure is directed to an assembly (also referred to herein as an optical assembly) that includes an optical device and a mounting member that is configured to removably, electrically and mechanically connect an optical component of the optical device to a printed board. The assembly further includes a housing that is configured to house the optical component. The housing is physically separate from the mounting member and is configured to mechanically connect to the mounting member such that the optical component is removably connected to the mounting member via the housing. The housing is also configured to electrically connect the optical component to the mounting member. The housing and mounting member define an electrically conductive pathway from the optical component to the printed board. The assembly also includes a cap that is configured to enclose the optical component in the housing. The cap may also be configured to mechanically and optically connect an optical fiber assembly to the optical component.

The housing may be modular, such that the optical component of the assembly can be relatively easily interchanged for another optical component. For example, the mounting member may be configured to receive a plurality of different housings, where each housing has a substantially similar configuration. A housing mechanically connected to the mounting member can be relatively easily interchanged with another housing that houses a different optical component (e.g., an updated optical component or a repaired optical component).

In one example, the disclosure is directed to an assembly comprising a housing defining a receptacle, an optical component within the receptacle of the housing, a cap configured to mechanically connect to the housing and substantially enclose the optical component in the receptacle, a mounting member configured to be mechanically connected to a printed board, wherein the mounting member is configured to removably mechanically connect to the housing and electrically connect the optical component to the printed board, and a plurality of electrical components. The plurality of electrical components and optical component are part of a common optical device, and the electrical components are not enclosed within the housing.

In another example, the disclosure is directed to a method comprising mechanically connecting a cap to a housing to substantially enclose an optical component in a receptacle defined by the housing, wherein the receptacle is substantially devoid of any electrical components of the optical device. The method further comprises mechanically connecting the housing to a mounting member, wherein the mounting member is configured to removably and mechanically connect to the housing and electrically connect the optical component to the printed board.

In another example, the disclosure is directed to an assembly comprising means for housing an optical component, wherein the means for housing the optical component does not house electrical components of the optical device. The assembly further comprises means for substantially enclosing the optical component in the means for housing, wherein the means for substantially enclosing is physically separate from the means for housing and configured to mechanically connect to the means for housing, and means for mounting the housing to a printed board, wherein the means for mounting is configured to be removably connected to the means for housing and electrically connect the optical component to the printed board.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a schematic cross-sectional view of an example assembly, which is mounted to a printed board and includes a mounting member, an optical component housing, an optical component, a cap, and an optical fiber assembly.

FIG. 2A is a schematic end view of the assembly shown in FIG. 1, and illustrates an optical component housing, cap, and optical fiber assembly of the assembly of FIG. 1.

FIG. 2B is a schematic cross-sectional view of the optical component housing, cap, and optical fiber assembly of the assembly of FIG. 1.

FIG. 2C is a schematic end view of the example assembly shown in FIG. 2B, and illustrates the end opposite that shown in FIG. 2A.

FIG. 3 is an exploded cross-sectional view of the optical component housing and cap shown in FIG. 1.

FIG. 4 is a schematic cross-sectional side view of the mounting member shown in FIG. 1.

FIG. 5 is a flow diagram of an example technique for assembling an assembly that include a mounting member, an optical component housing, an optical component, a cap, and an optical fiber assembly.

FIG. 6 is a schematic perspective view of another example assembly, which is mounted to a printed board via bolts.

### DETAILED DESCRIPTION

An optical assembly may include an optical device mounted on a printed board and an optical fiber optically connected to the optical device. The optical device can comprise an optical component (e.g., an optical integrated circuit that includes a light emitting diode and/or a light detecting diode) and supporting electrical components, such as one or more controllers (e.g., an integrated circuit that acts as a controller for the optical device). As examples, the optical device may comprise a semiconductor laser device, an optical amplifier, an optical modulator (e.g., optical phase or intensity modulator), an optical switch, a semiconductor light receiving device, an optical coupler, an optical wavelength multiplexer/demultiplexer, supporting passive optical components such as isolators, circulators, power beamsplitters or combiners, and polarization beam splitters and combiners, or another optical device

In some systems, an optical device includes an optical component and supporting electrical components that are substantially or fully enclosed in a common housing, which is configured to be mounted directly to a printed board (which may also be referred to as a circuit card). For example, the optical component (e.g., an optical integrated circuit enclosed in an integrated circuit package) and supporting electrical components can be mounted on a printed board, which is then enclosed in a common housing that is soldered to a separate printed board. As another example, an optical device component and supporting electrical components may be substantially or fully enclosed in a common housing, which is configured to be removably mounted to the printed board. While these configurations may be useful, there may also be disadvantages to these configurations. For example, if the optical component fails, part of the printed board or the entire printed board may be unuseable because of the inability to relatively easily access the optical component. In examples in which the optical device housing that houses the optical component and supporting electrical components is soldered or otherwise securely attached to the printed board, the optical component may not be replaceable or may be expensive to replace because of difficulties in accessing the optical component. For example, the optical device may need to be removed from the printed board and deconstructed in order to access the optical component, thereby compromising the integrity of the printed board and the optical device.

The configurations in which the optical component is enclosed in a common housing with some or all of the supporting electrical components may also be relatively bulky because of the weight added by the supporting electrical components. An assembly including an optical device mounted on a printed board may be used in many different applications, including applications in which the assembly is subjected to relatively high vibration (e.g., in space applications). As the weight of the optical device mounted to the printed board increases, the vulnerability of the printed board assembly to vibration-induced stresses may increase. Thus, it may be useful to decrease the weight of the optical device that is mechanically connected to the printed board.

In example assemblies described herein, an optical device is configured to be at least partially removably attached to a printed board, such that an optical component of the optical device can be relatively easily accessed and even replaced without replacing the entire optical device or the entire printed board, and without compromising the integrity of the other parts of the optical device and printed board. In addition, all or some of the supporting electrical components of the optical assembly may be separately mounted to the printed board, thereby reducing the weight of the components of the optical device mounted to the printed board compared to printed board assemblies in which the optical component and supporting electrical components are enclosed in a common housing that is mechanically connected to a printed board (e.g., mounted via through-hole or surface mount techniques). All or some non-critical electrical components are placed outside of the housing module (in which the optical component is mounted) to be mounted on the printed board, thereby resulting in a lighter, mechanically robust solution. By reducing the weight of the optical device, improvements in the resistance of the printed board assembly can be achieved, including reductions in susceptibility of the optical device to vibration-induced stresses compared to examples in which the optical component and supporting electrical components are enclosed in a common housing that is mechanically connected to the printed board.

The assemblies described herein include modular parts in that the components, such as the optical device housing, optical fiber assembly, mounting member, and cap are configured to be separated and recombined multiple times without substantially adversely affecting the integrity of the parts. The modularity of the assemblies can be useful for, for example, replacing, interchanging, or repairing one or more parts of the assembly without requiring replacement of the entire assembly.

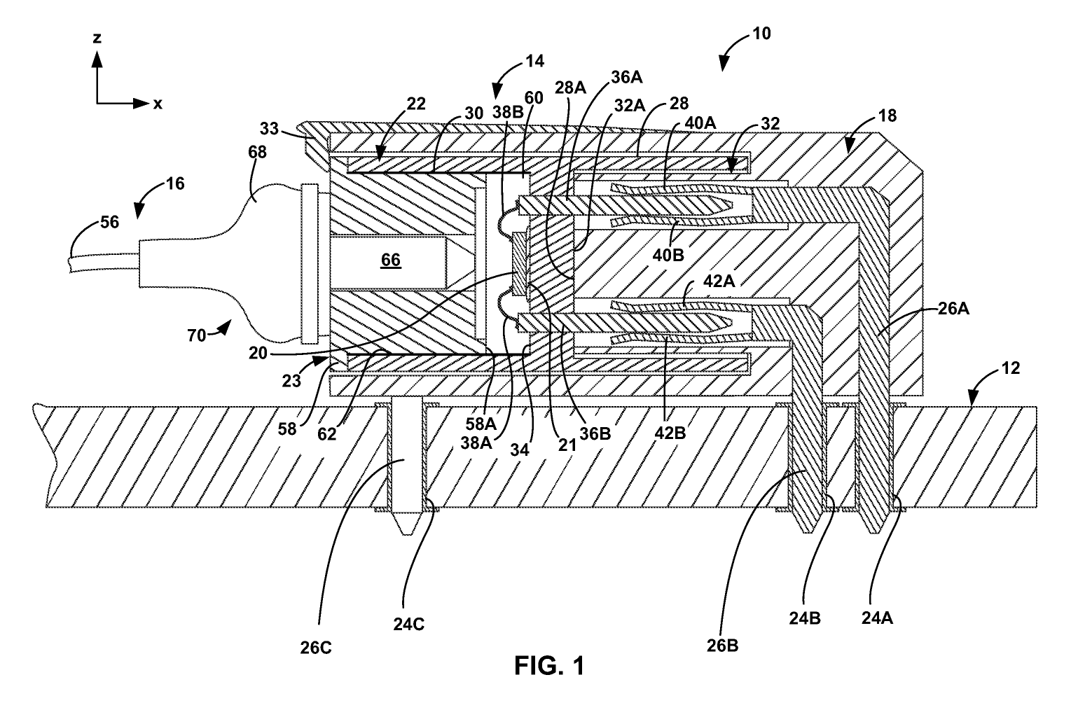

FIG. 1 is a schematic cross-sectional view of an example assembly 10, which includes a printed board 12, an optical device 14, and an optical fiber assembly 16. The cross-section is taken through a center of optical device 14 along the x-z plane (orthogonal x-z axes are shown in FIG. 1 for ease of description only). Assembly 10 may also be referred to as a printed board assembly or an optical assembly in some cases. In the example shown in FIG. 1, optical device 14 is configured to be mounted to printed board 12, which may, for example, electrically connect optical device 14 to other electrical components, such as some or all of the electrical components of optical device 14 (e.g., the electrical components necessary to the operation of optical device 14 in its intended use).

In the example shown in FIG. 1, optical device 14 includes a mounting member 18, an optical component 20, a housing 22 that houses optical component 20, and a cap 23. Mounting member 18, optical component 20, housing 22, and cap 23 are physically separate from each other (e.g., movable in six degrees of freedom with respect to each other) and configured to mechanically connect to each other. Mounting member 18, optical fiber assembly 16, housing 22, and cap 23 are modular parts of assembly 10 in that mounting member 18, optical fiber assembly 16, housing 22, and cap 23 are configured to be separated and recombined multiple times without substantially adversely affecting the integrity of the parts.

Optical component 20 may be any suitable optical component, such as a component that acts as a light emitter or a light detector or includes an optical element, such as a light emitter (e.g., a light emitting diode, an organic light emitting diode, or another semiconductor light source) or a light detector. While optical component 20 is primarily referred to as an integrated circuit (e.g., an optical application-specific integrated circuit, or “OASIC”) with respect to the description of the figures, in other examples, optical component 20 can be any suitable optical component, such as a semiconductor laser or superluminescent diode, avalanche or PIN photodiode, vertical cavity surface-emitting laser (VCSEL), and the like. In some cases, the OASIC can be a combination of the above components, such as an integrated laser, monitor diode, thermo-electric cooler, and the like.

Mounting member 18, housing 22, and cap 23 may be formed from any suitable material, such as, but not limited to, a ceramic material, a metal, a plastic, or any combinations thereof. In some examples, at least two or all of the mounting member 18, housing 22, and cap 23 are formed from the same material. In other examples, at least two or all of the mounting member 18, housing 22, and cap 23 are formed from different materials. In addition, in some examples, housing 22 and cap 23 have substantially similar or event identical coefficients of thermal expansion. It can be desirable to substantially match the coefficients of thermal expansion of housing 22 and cap 23 in order to maintain alignment between optical fiber assembly 16 and optical component 20, even during operation of assembly 10 when heat is generated by elements (e.g., optical device 14) mounted to printed board 12.

Optical device 14 is mechanically and electrically connected to printed board 12 via mounting member 18. In the example shown in FIG. 1, printed board 12 defines openings 24A, 24B, 24C (collectively referred to as “openings 24”) that are configured to receive corresponding pins 26A, 26B, 26C (collectively referred to as “pins 26”) of mounting member 18. In some examples, when pins 26A, 26B, 26C are introduced in the respective opening 24A, 24B, 24C, pins 26 may be friction fit within the respective opening 24 to mechanically secure mounting member 18 to printed board 12. In addition or instead of a friction fit, in some examples, pins 26 may be soldered or adhered to the respective opening 24. In some examples, the configuration of pins 26 and openings 24 may be selected such that pins 26 self-align optical device 14 with printed board 12, e.g., such that pins 26 can only be received in printed board 12 in one orientation.

In some examples, such as the example shown and described with respect to FIG. 6, mounting member 18 can be mechanically secured to printed board 12 via one or more through-hole bolts that extend through both mounting member 18 and printed board 12. The bolts may extend through mounting member 18 in a manner that does not interfere with the electrical connections through mounting member 18 to printed board 12.

In addition to providing a mechanical connection between printed board 12 and optical device 14, mounting member 18 electrically connects optical device 14 to printed board 12. Mounting member 18 defines a part of an electrically conductive pathway from optical component 20 to printed board 12. In the example shown in FIG. 1, mounting member 18 is electrically connected to printed board 12 using a through hole mounting technology. For example, as shown in FIG. 1, each of the openings 24A, 24B defined by printed board 12 includes an electrically conductive portion that is electrically connected to one or more traces and/or vias of printed board 12. In some examples, the surface of openings 24A, 24B that contact pins 26A, 26B when pins 26A, 26B are introduced in openings 24A, 24B are plated with an electrically conductive material, such as copper, nickel, palladium, palladium/nickel alloy gold, rhodium, tin/nickel alloy, and any combinations thereof. At least a part of pins 26A, 26B of mounting member 18 can be electrically conductive, such that when pins 26A, 26B are introduced in openings 24A, 24B and contact (directly or indirectly, e.g., via an electrically conductive interface material) the electrically conductive portions of openings 24A, 24B, an electrically conductive path between printed board 12 (e.g., one or more electrically conductive traces or vias of printed board 12) and mounting member 18 is defined by the pins 26A, 26B and openings 24A, 24B.

In the example shown in FIG. 1, pin 26C of housing 22 is not directly electrically connected (e.g., via a conductive trace or via) to any features of mounting member 18, and is positioned to provide mechanical stability to mounting member 18 when mounting member 18 is mounted in printed board 12. Pin 26C is spaced from pins 26A, 26B in the x-axis direction, near the opposite end of mounting member 18 than pin 26A, such that pin 26C interfaces with a different part of printed board 12 than pins 26A, 26B. The spacing of pin 26C from pins 26A, 26B may help increase the mechanical stability of mounting member 18 on printed board 12, which may help, for example, improve the stability of mounting member 18 on printed board 12 in the presence of vibration-induced forces. In some examples, pin 22 may provide a ground connection from mounting member 18 to board 12, in which case opening 24C in printed board 12 may be, but need not be, electrically connected to a ground plane layer of printed board 12.

In some examples, pin 26C may be formed from the same electrically conductive material as pins 26A, 26B, while, in other examples, pin 26C may be formed from a different material, such as an electrically nonconductive material. In addition, opening 24C corresponding to pin 26C may be configured the same as openings 24A, 24B, or may be different than (e.g., electrically nonconductive) than openings 24A, 24B. Additionally, in some examples, any one or more of pins 26A-26C may be used to provide a thermally conductive pathway between printed board 12 and optical device 14, which can help conduct heat away from device 14. For example, one or more of the pins 26A, 26B, 26C can also be configured to be thermally conductive, and may define a thermally conductive pathway from optical component 20 (which may generate heat during its operation) to printed board 12. In some examples, the one or more thermally conductive pins 26A, 26B, 26C are thermally connected to a thermally conductive pathway (e.g., a thermally conductive trace) of printed board 12. Multiple thermally conductive pathways (defined by two or more pins 26A-26C) away from component 20 may help transfer heat away from component 20 more efficiently than a single conducive pathway.

Housing 22 is configured to house and retain optical component 20, such that optical component 20 is in a fixed position relative to housing 22. In some examples, housing 22 only houses one or more optical components, such as one or more OASICs. In some examples, housing 22 is formed from a material that is configured to help protect optical component 20 from forces applied to printed board assembly 10. For example, housing 22 may be formed from a substantially rigid material that acts as a physical barrier, which helps protect optical component 20 from the application of direct forces. In addition, as described in further detail below, housing 22, together with cap 23, may define a hermetically or near hermetically sealed receptacle 30 in which optical component 20 is positioned. In this way, housing 22 and cap 23 may help protect optical component 20 from environmental contaminants, such as moisture and debris. By reducing the moisture and other contaminants to which optical component 20 is exposed may help reduce chemical corrosion of optical component 20, the useful life of optical device 14 and printed board assembly 10 may be increased. In the example shown in FIG. 1, receptacle 30 of housing 22 is substantially devoid of any electrical components (e.g., a controller) of optical device 14.

In the example shown in FIG. 1, housing 22 defines receptacles 28, 30, which each include, for example, side walls that define an open cavity. The cavities defined by receptacles 28, 30 face substantially different directions, and, in the example shown in FIG. 1, face substantially opposite directions. Component 20 is positioned within receptacle 30. As discussed below, receptacle 30 is configured to interface with mounting member 18.

Housing 22 is configured to be mechanically connected to mounting member 18, and electrically connect optical component 20 to mounting member 18. In the example shown in FIG. 1, housing 22 and mounting member 18 include complementary shapes, such that housing 22 and mounting member 18 are configured to mate together. For example, in the example shown in FIG. 1, mounting member 18 and housing 22 define a plug and socket, respectively. Housing 22 defines receptacle 28 that is configured (e.g., has a size and geometry) to receive plug portion 32 defined by mounting member 18. In the example shown in FIG. 1, plug portion 32 is received in receptacle 28, such that an end face 32A of plug portion 32 contacts an inner surface 28A of receptacle 28. In this way, inner surface 28A of receptacle 28 may act as a stop for plug portion 32, such that when optical device 14 is assembled, receptacle 28 provides a tactile indication when mounting member 18 is completely introduced into housing 22. For example, when the assembler encounters resistance when introducing plug portion 32 into receptacle 28, the assembler may determine that plug portion 32 is substantially completely introduced into receptacle 28.

Mounting member 18 and housing 22 can be secured to each other using any suitable technique, such as using an adhesive or a mechanical feature (e.g., a latching mechanism, friction fit, or the like). In the example shown in FIG. 1, mounting member 18 and housing 22 are removably attached to each other, such that, if needed, housing 22 can be relatively easily disengaged from mounting member 18 without compromising (e.g., without interrupting or significantly interrupting) the electrical connection between mounting member 18 and printed board 12. In this way, mounting member 18 is configured to removably mechanically couple housing 22, and, therefore, optical component 20, to printed board 12.

Any suitable technique can be used to removably attach mounting member 18 to housing 22. In the example shown in FIG. 1, mounting member 18 includes latching mechanism 33, which engages with cap 23 to help secure cap 23, as well as housing 22 that is connected to cap 23, to mounting member 18. Latching mechanism 33 is configured to flex without breakage, such that it may be flexed from an initial position to a flexed position away from receptacle 30 (e.g., in the positive z-axis direction). In this way, latching mechanism 33 may be flexed away from housing 22 when introducing plug portion 32 into receptacle 28, and then returned to its initial, resting position, in which latching mechanism 33 engages with an end face of cap 23 to substantially hold (e.g., with minimal to no relative movement) cap 23 and housing 22 in place. When disengagement of cap 23 and/or both cap 23 and housing 22 from mounting member 18 is desired, latching mechanism 33 may be flexed away from housing 22, such that it does not engage the end face of cap 23, and cap 23 and, in some examples, housing 22 may be pulled away from mounting member 18 (e.g., in the negative x-axis direction).

While one latching mechanism 33 is shown in FIG. 1, in other examples, a plurality of latching mechanisms (e.g., two or more) can be used to removably secure housing 22 to mounting member 18. The one or more latching mechanisms may be configured to reduce relative motion (e.g., induced by vibration) between housing 22 and mounting member 18, which may increase the robustness and integrity of the electrical connection between optical component 20 and printed board 12. For example, latching mechanism 33 may be configured to reduce movement of cap 23 and housing 22 away from mounting member 18.

In addition, or instead, of securing mounting member 18 to printed board 12 via one or more through-hole bolts, in some examples, housing 22 can be mechanically secured to printed board 12 via through-hole bolts that extend through both housing 22 and printed board 12. The bolts may extend through housing 22 in a manner that does not interfere with the optical pathways or electrical pathways through housing 22, or interfere with the hermiticity of receptacle 30.

Optical component 20 resides within receptacle 30, and, in the example shown in FIG. 1, is mechanically connected to supporting surface 34 of housing 22, which is one surface that defines receptacle 30. In some examples, some or all surfaces of receptacle 30 may have a layer of material (e.g., may be coated or painted) that affects the optical properties of the surfaces of receptacle 30, e.g., such that the surfaces are optically absorbing in the range of operating optical wavelengths of optical component 20. The layer of material (e.g., coating or painting) may reduce stray or reflected light which may otherwise interfere with the desired optical signal.

Optical component 20 may be, for example, directly or indirectly (e.g., via interface material 21 in the example shown in FIG. 1) mounted to supporting surface 34. In some examples, interface material 21 comprises an adhesive or solder. Interface material 21 can be thermally conductive in some examples, and configured to help conduct heat away from component 20. In this way, surface 34 of housing 22 can act as a heat sink for component 20 or at least define a thermally conductive pathway from component 20 to a heat sink of printed board 12. In some examples, interface material 21 is electrically insulative, while in other examples, interface material 21 is electrically conductive.

Optical component 20 may generate heat as it operates. In order to extend the operational temperature range performance for optical device 14, it can be desirable to reduce the thermal path length, and, therefore, lower the thermal resistance, from optical component 20 to a heat sink (e.g., to housing 22 or a heat sink in printed board 12). Compared to optical devices in which optical component 20 is enclosed in a common housing with a plurality of supporting electrical components, optical device 14 may define a shorter thermal path length from optical component 20 to a heat sink because of its relatively smaller size. Thus, the configuration of optical device 14 may provide improved conductive cooling properties for optical component 20 compared to optical devices in which optical component 20 is enclosed in a common housing with a plurality of supporting electrical components.

Housing 22 further comprises pins 36A, 36B, which are at least partially formed from electrically conductive material and are configured to define an electrically conductive pathway from component 20 to mounting member 18 when housing 22 and mounting member 18 are mated together. While two pins 36A, 36B are shown in FIG. 1, in other examples, housing 22 can include any suitable number of electrically conductive pins, and mounting member 18 can include any suitable number of corresponding contacts for electrically connecting to the pins.

In the example shown in FIG. 1, pins 36A, 36B each extends from one receptacle 30 to the other receptacle 28. Pins 36A, 36B can be electrically connected to optical component 20 using any suitable technique. In the example shown in FIG. 1, component 20 is electrically connected to pins 36A, 36B via leads 38A, 38B, respectively. Leads 38A, 38B comprise an electrically conductive material that is configured to define an electrically conductive pathway from component 20 to pins 36A, 36B. Leads 38A, 38B may be electrically and mechanically connected to pins 36A, 36B and component 20 using any suitable mechanism, such as by soldering or wire-bonding ends of leads 38A, 38B to a respective pin 36A, 36B, and to a respective electrical contact on component 20.

In other examples, component 20 may be electrically connected to pins 36A, 36B using another technique in addition to or instead of leads 38A, 38B. For example, rather than protruding into receptacle 30, as shown in the example of FIG. 1, the ends of pins 36A, 36B may be substantially flush with supporting surface 34 in receptacle 30, and component 20 may sit on top of the ends of pins 36A, 36B. Electrical contacts of component 20 may be substantially aligned with the ends of pins 36A, 36B, such that the contacts are directly or indirectly (e.g., via an interface material) electrically connected to pins 36A, 36B. In some examples, component 20 may be positioned on surface 34 in a flip-chip orientation (e.g., flipped relative to the orientation shown in FIG. 1), such that the electrical contacts of component 20 face surface 34, and the electrical contacts may be electrically connected to the pins using any suitable attachment mechanism, such as a ball grid array, an electrically conductive columns, a solder, a plurality of conductive pins, or another type of connection.

In some examples, pins 36A, 36B may not extend through supporting surface 34 and into receptacle 30. Rather, to make an electrical connection from one receptacle 28 to another 30, electrically conductive vias can extend through the thickness of surface 34, such that the electrically conductive vias are exposed to in both cavities 28, 30. Component 20 may be electrically connected (e.g., via leads or a flip chip configuration) to the side of the electrically conductive vias in supporting surface 34 that are exposed to cavity 30, and pins 36A, 36B may be electrically connected to the side of the electrically conductive vias exposed to the other cavity 28.

Pins 36A, 36B are configured to electrically connect to mounting member 18 when mounting member 18 and housing 22 are mechanically connected to each other. In the example shown in FIG. 1, pins 36A, 36B are configured to electrically connect to pins 26A, 26B, respectively, of mounting member 18. An electrical connection between respective pins 26A, 26B and 36A, 36B may be defined using any suitable technique. For example, pins 26A, 26B may directly contacts pins 36A, 36B in some examples. As another example, pins 26A, 26B may indirectly contacts pins 36A, 36B, e.g., through an intervening electrically conductive member. An example of this type of configuration is shown in FIG. 1.

Movable member 18 comprises a first set of electrically conductive prongs 40A, 40B and a second set of electrically conductive prongs 42A, 42B. The prongs 40A, 40B and 42A, 42B of each set are movable with respect to the each other. One end of each of movable prongs 40A, 40B is electrically connected to and attached to pin 26A of mounting member 18. The opposite ends of prongs 40A, 40B are movable relative to each other, but prongs 40A, 40B are configured to be biased towards each other. In an initial, relaxed position in which no force is applied to prongs 40A, 40B, movable prongs 40A, 40B are in a first position. Upon the application of force, movable prongs 40A, 40B may be moved away from each other, i.e., into a second position. However, because prongs 40A, 40B are biased towards each other, they are inclined to move back to the first position, even in the presence of the force. Thus, when pin 36A of housing 22 is introduced between prongs 40A, 40B, as shown in FIG. 1, prongs 40A, 40B engage with an outer surface of pin 36A. In this way, prongs 40A, 40B electrically connect pin 36A of housing 22 to pin 26A of mounting member 18.

Prongs 42A, 42B of mounting member 18 have a configuration similar to prongs 40A, 40B. Accordingly, when pin 36B of housing 22 is introduced between prongs 42A, 42B, prongs 42A, 42B engage with an outer surface of pin 36B, thereby electrically connect to pin 36A. As a result, prongs 42A, 42B electrically connect pin 36B of housing 22 to pin 26B of mounting member 18.

The mating portions (e.g., plug portion 32 and receptacle 28) of mounting member 18 and housing 22 may help align housing 22 with mounting member 18, such that when mounting member 18 and housing 22 are mechanically connected, pins 36A, 36B of housing 22 are properly aligned with and received by the space defined by the respective sets of prongs 40A, 40B, and 42A, 42B.

In the example shown in FIG. 1, two prongs 40A, 40B are used to electrically connect pins 26A, 36A, and two prongs 42A, 42B are used to electrically connect pins 26B, 36B. In other examples, another number of prongs can be used to electrically connect pins 26A, 36A, and pins 26B, 36B. For example, a single prong or more than two prongs could be used to connect a pin of mounting member 18 to a pin of housing 22. The additional prong can be non-electrically conductive in some examples. As another example, a single electrically conductive prong can be used to connect respective pins 26A, 26B and 36A, 36B. The prongs can have any suitable configuration.

As shown in FIG. 1, in some examples, cap 23 of optical device 14 is configured to removably receive optical fiber assembly 16, which provides assembly 10 with more flexibility to mate and demate optical fibers from printed board 12 compared to examples in which optical fiber assembly 16 is permanently affixed to an optical device. In contrast to a system in which optical fiber assembly 16 is permanently affixed to an optical device, an optical device that is configured to removably receive optical fiber assembly 16 may have one or more advantages in one or more situations. For example, optical device 14 may be easier to manipulate without a connected optical fiber assembly 16 when device 14 is being connected to printed board 12, e.g., due to the smaller size of device 14 without a connected optical fiber assembly 16. If multiple optical devices are connected to printed board 12, printed board 12 may be relatively congested with multiple optical fiber assemblies 16. Thus, in some examples, in order to better view and access printed board 12, it may be desirable to connect optical device 14 to printed board 12 prior to connecting optical fiber assembly 16 to optical device 14.

In addition, optical device 14 that is configured to removably connect to optical fiber assembly 16 may be permit optical fiber assembly 16 to be relatively easily removed or replaced without affecting the integrity of the connection between optical device 14 and printed board. This may be useful, for example, if optical fiber assembly 16 (e.g., one or more of its constituent parts) needs to be replaced, e.g., to be updated or repaired, in which case the new or repaired optical fiber assembly 16 can be relatively easily introduced into optical device 14 while device 14 remains electrically and mechanically connected to printed board 12. Removably connecting optical fiber assembly 16 to optical device 14 may permit optical device 14 to be removed from printed board 12 or repaired relatively easily.

In some examples, optical fiber assembly 16 and/or cap 23 can be keyed or marked so as to allow optical fiber assembly 16 to be azimuthally aligned to optical component 20. In some examples, such alignment may be useful for configuring system 10 such that optical component 20 receives and/or transmits optical signals via optical fiber assembly 16 with a relatively well-defined optical polarization state.

Cap 23 is configured to at least partially or completely cover receptacle 30 defined by housing 22. In the example shown in FIG. 1, cap 23 completely encloses optical component 20 in receptacle 30, and, in particular, in cavity 60 defined by housing 22 and cap 23. As discussed above, cap 23 is removably connected to housing 22 of optical device 14. After optical device 14 is assembled, e.g., as shown in FIG. 1, cap 23 can be relatively easily removed from receptacle 28, by disengaging latching mechanism 33 from cap 23 and pulling cap 23 away from housing 22 (e.g., in a negative x-axis direction). Cap 23 can be removed from housing 22 while optical fiber assembly 16 is detached from cap 23 or while optical fiber assembly 16 is still connected to cap 23.

When cap 23 is removed from housing 22, optical component 20 positioned in receptacle 30 is exposed and can be accessed relatively easily. In this way, optical device 14 is configured such that, even after optical device 14 is connected to printed board 14, and even after optical fiber assembly 16 is connected to device 14, optical component 20 may be accessed. Accessing optical component 20 may be desirable during testing or rework of optical device 14.

Optical device 14 that includes cap 23 that is removably connected to housing 22 of optical component 20 may also be useful during assembly of optical device 14. For example, optical component 20 can be attached to housing 22 even after housing 22 and mounting member 18 are mechanically connected to printed board 12. In addition or instead, the configuration of optical device 14 enables leads 38A, 38B to be electrically connected to component 20 and/or pins 36A, 36B, respectively, after housing 22 is connected to mounting member 18, and, in some examples, after housing 22 and mounting member 18 are mechanically connected to printed board 12.

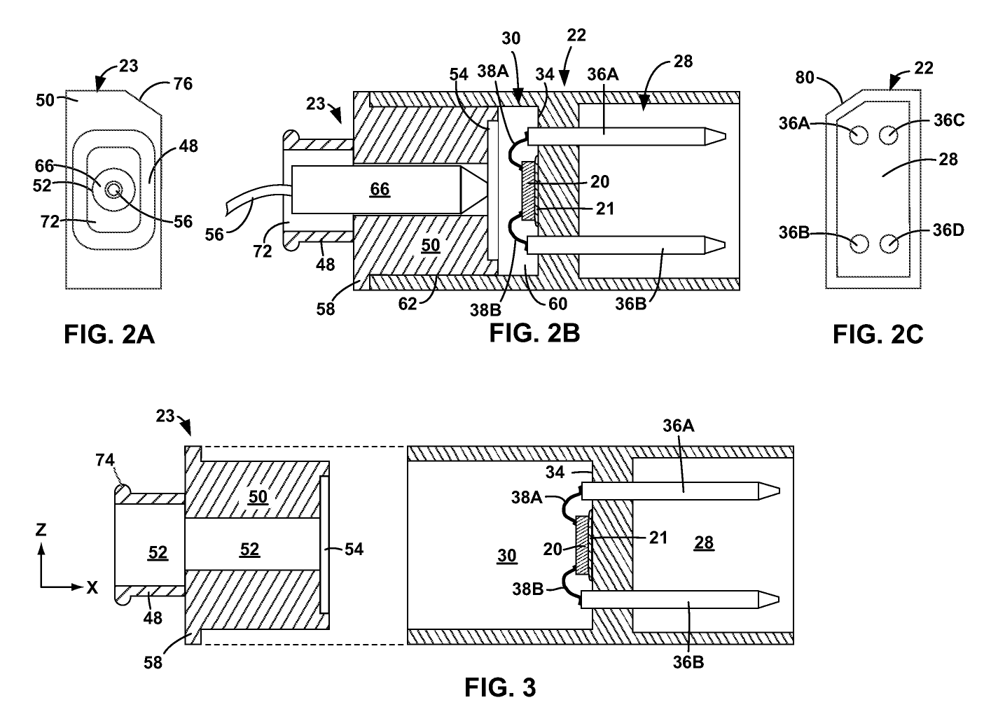

Cap 23 of optical device 14 includes neck portion 48 (shown in FIGS. 2B and 3) and main body 50, which both define pathway 52 (shown in FIGS. 2A, 2B, and 3) that is configured to receive a part of optical fiber assembly 16. Cap 23 further includes window 54, which defines an optically conductive pathway through which light from optical fiber assembly 16 may traverse to reach optical component 20. In this way, cap 23 defines an optically conductive pathway that optically couples optical fiber assembly 16 (and, in particular, optical fiber 56 of optical fiber assembly 16) with component 20. Window 54 may be, for example, substantially transparent and may comprise glass, plastic, quartz, silicon, or another translucent material. In some examples, window 54 can have spectrum filter properties. In addition, in some examples, window 54 also functions as a lens, in which case window 54 may define a concave or convex shape. In some examples, window 54 may be coated with anti-reflection coating for a particular optical wavelength range. In addition, or instead, in some examples, window 54 may be placed or cut at an angle with respect to the symmetry axis of optical device 14 to reduce unwanted back-reflections.

Main body 50 of cap 23 is configured to be received in receptacle 30 defined by housing 22. As shown in FIG. 1, main body 50 is sized to fit within receptacle 30 and includes flange 58, which is configured to engage with housing 22 and acts as a stop to prevent further movement of main body 50 towards optical component 20 (in the positive x-axis direction shown in FIG. 1). Flange 58 can extend around the entire outer perimeter of main body 50 or only part of the outer perimeter of main body 50. In the example shown in FIG. 1, main body 50 is sized such that when main body 50 is introduced in receptacle 30 such that flange 58 engages with housing 22, end face 48A of main body 50 does not contact optical component 20. Rather, together, end face 48A and housing 22 define cavity 60 (which is a part of receptacle 30) in which optical component 20 is positioned. In some examples, cavity 60 is hermetically sealed or partially hermetically sealed.

In order to improve the hermiticity of cavity 60, in some examples, seal 62 is positioned at the interface between main body 50 and housing 22. In some examples, such as the example shown in FIG. 1, seal 62 extends along the entire interface between main body 50 and housing 22. In other examples, seal 62 may be positioned only along part of the interface between main body 50 and housing 22. Seal 62 may be, for example, any suitable adhesive that has the desired properties (e.g., substantially impermeable to fluids). In some examples, seal 62 is tapered (e.g., at an angle in the x-z plane) to accommodate different adhesive thicknesses (if an adhesive is used to secure main body 50 of cap 23 to housing 22) and ease of insertion of cap 23 into housing 22. Seal 62 may be, for example, relatively compressible such that when cap 23 is inserted into housing 22, seal 62 is compressed, which may define a more dense seal 562, thereby helping further seal the interface between main body 50 and housing 22 from the intrusion of environmental contaminants.

In some examples, seal 62 may be configured to secure main body 50 of cap 23 to housing 22. Thus, optical device 14 may include seal 62 even in examples in which cavity 60 is not near hermetically or hermetically sealed. In these examples, seal 62 may not be configured to improve the hermiticity of cavity 60. However, in some examples, optical device 14 does not include a seal or the like to secure cap 23 to housing 22 in addition to latching mechanism 33, which secures mounting member 18, housing 22, and cap 23 together.

Main body 50 and neck portion 48 are integrally formed (e.g., formed or molded of one common material so as not to require any assembly) in some examples. In other examples, main body 50 and neck portion 48 are separate pieces that are mechanically connected together, e.g., via an adhesive, welding, fasteners (e.g., screws and/or bolts) or the like. In some examples, neck portion 48 is configured to receive and engage with optical fiber assembly 16.

In the example shown in FIG. 1, optical fiber assembly 16 includes optical fiber 56, ferrule 66, and strain relief member 68. Neck portion 48 has a smaller z-axis dimension than main body portion 50 in some examples, to accommodate strain relief member 68, which is connected to neck portion 48 in the example shown in FIG. 1.

Optical fiber 56 is configured to transmit light (e.g., from one end to another), and can be configured for single-mode or multi-mode operation. For example, optical fiber 56 can comprise a transparent core surrounded by a transparent cladding material with a lower index of refraction. Instead, or in addition, optical fiber 56 can comprise a micro-structured fiber, such as hollow-core photonic crystal or bandgap fiber. Ferrule 66 is configured to be attached to an end of optical fiber 56 that is introduced into cap 23, which is the end of optical fiber 56 that transmits light to optical component 20, through window 54. In the example shown in FIG. 1, an end of optical fiber 56 is terminated in ferrule 66 and is held in a fixed position relative to ferrule 66. As a result, ferrule 66 helps to align fiber 56 with window 54, and, therefore, optical component 20, when housing 22 is connected to mounting member 18. Optical fiber 56 can be retained in ferrule 66 using any suitable technique, such as using any one or more of a friction fit, an adhesive, welding, or a mechanical fastening mechanism (e.g., crimping ferrule 66 to fiber 56). In some examples, the endface of optical fiber 56 may be coated with an anti-reflection coating for a particular optical wavelength range or may be angle-cut or angle-polished to reduce unwanted back-reflections.

Ferrule 66 may be more rigid than optical fiber 56 in some examples, such that ferrule 66 connected to an end of optical fiber 56 may increase the ease with which optical fiber assembly 16 can be manipulated and introduced into cap 23. In addition, ferrule 66 may permit optical fiber assembly 16 to be repeatedly introduced and removed from cap 23 while minimizing any deformation to fiber 56 that may affect the performance of fiber 56 compared to examples in which fiber 56 is directly introduced into cap 23. In other examples, optical fiber 56 may be directly introduced into pathway 52 defined by cap 23, i.e., without ferrule 66.

Pathway 52 defined by cap 23 is configured to receive ferrule 66 of optical fiber assembly 16. Pathway 52 is positioned relative to component 20 such that when ferrule 66 is introduced in pathway 52, the end of optical fiber 56 that is configured to transmit and receives light is aligned with the relevant part of optical component 20, and optically coupled to optical component 20. Pathway 52 of cap 23 guides optical fiber assembly 16 into place relative to component 20, thereby reducing or even eliminating the need for manual alignment of optical fiber 56 to optical component 20.

With some types of optical components 20, even relatively small variations in alignment between fiber 56 and component 20 may adversely affect the performance of optical device 14. Thus, with some optical devices 14, it can be desirable to maintain a relatively precise alignment between optical fiber 56 and optical component 20, such as within a variance of less than 10 micrometers, in order for the optical device to perform as desired. For example, if optical component 20 includes a light detector, it can be desirable for light from optical fiber 56 to be transmitted to optical component 20 at a relatively precise location in order for optical component 20 to properly detect the light or the desired properties of the light. As another example, if optical component 20 includes a light emitter, it can be desirable for optical fiber 56 to be aligned with the emitter component of component 20 in order to maximize the power transmitted through optical fiber 56. Cap 23 is configured to help reduce any variation in alignment between fiber 56 and component 20 during operation of printed board assembly 10.

Any suitable technique can be used to align optical fiber 56 with optical component 20, as well as maintain the relative position between optical component 20 and optical fiber 56. Fixing a position of ferrule 66 relative to pathway 52 may help reduce the variation in the location that light from optical fiber 56 is incident on window 54, which may help reduce the variation in the location light from optical fiber 56 is incident on optical component 20. In some examples, the portion of pathway defined by main body 50 of cap 23 is sized and configured to friction fit with ferrule 66, as shown in FIG. 1. In addition to or instead of a friction fit, a fill material, such as an adhesive, a non-adhesive fill material, or the like, can be introduced between ferrule 66 and pathway 52 within main body 50 in order to help hold ferrule 66 in place relative to pathway 52. The fill material may also help protect cavity 60 from contaminants, e.g., by reducing the contaminants, if any, that may traverse through window 54.

Optical fiber 56 projects away from cap 23 and may bend in a particular direction relative to cap 23, e.g., toward printed board 12, due to the effects of gravity. It may be desirable to reduce the extent to which optical fiber 56 bends because the performance of fiber 56 may be affected by the bend radius of fiber 56. For example, fiber 56 may experience power loss if the bend radius of fiber 56 is relatively large. It may also be desirable to reduce the total number of bending cycles (e.g., in which optical fiber 56 bends from shape to another) to which fiber 56 is subjected in order to maintain the structural integrity of fiber 56 (e.g., prevent fracturing or other structural issues that may affect the performance of fiber 56).

In order to help reduce the bend radius of optical fiber 56 at a point that may be relatively susceptible to bending and to relieve some stress applied to fiber 56 during multiple bending cycles, optical fiber assembly 16 includes strain relief member 68. Strain relief member 68 is configured to provide a relatively smooth transition from ferrule 66 to the environment outside of optical device 14. Strain relief member 68 is positioned adjacent ferrule 66 and is configured to reduce the strain applied to optical fiber 56, e.g., the portion of optical fiber 56 at region 70 near the interface of fiber 56 and an end of cap 23. For example, strain relief member 68 can be configured to reduce the movement (e.g., bending) of optical fiber 56 relative to ferrule 66, and/or configured to reduce the bend radius of fiber 56 at the interface between ferrule 66 and fiber 56. In this way, strain relief member 56 may help maintain the power transmitted by optical fiber 56 at a certain minimum level. Strain relief member 68 can be flexible, but less flexible relative to fiber 56, in order to permit fiber 56 to move relative to cap 23 even when strain relief member 68 is applied to fiber 56.

Strain relief member 68 can be attached to optical fiber 56 using any suitable technique, such as via friction fit, an adhesive, a mechanical fastener, or any combination thereof. In the example shown in FIG. 1, strain relief member 68 is configured to fit over neck portion 48 of cap 23, e.g., after or at the same time ferrule 66 is introduced into pathway 52 of cap 23. Strain relief member 68 can be attached to cap 23 using any suitable technique, such as via friction fit, an adhesive, a mechanical fastener, or any combination thereof.

FIGS. 2A-2C are additional illustrations of a part of assembly 10. FIG. 2A is a schematic cross-sectional end view of assembly 10, where the cross-section is taken along the y-z plane in FIG. 1, at the interface between cap 23 and strain relief member 68. FIG. 2A illustrates an end view of cap 23, and, in particular an end view of neck portion 48 and main body 50 of cap 23. FIG. 2A also illustrates an end view of ferrule 66, which is introduced in pathway 52 defined by cap 23, and a cross-sectional view of optical fiber 56. As FIG. 2A illustrates, fill material 72 is positioned between the outer surface of ferrule 66 and the inner surfaces of cap 23 that define pathway 52.

In some examples, as shown in FIG. 2, fill material 72 can be used to substantially completely fill the space between cap 23 and ferrule 66 in pathway 52, which may help hold ferrule 66 substantially in place within pathway 52. Fill material 72 can also be configured to help prevent environmental contaminants, including water, from entering cavity 60 in which optical component 20 is placed. In this way, fill material 72 may help hermetically seal cavity 60 in some examples. In some examples, fill material 72 comprises an epoxy, a polymer, an adhesive, or the like. In some examples, fill material 52 can be a relatively flexible sealant in order to reduce the stress and strain on optical fiber assembly 16. However, in some examples, some rigidity to fill material 72 may be desirable in order to help fix the position of ferrule 66 relative to cap 23. Fill material 72 can be introduced into the space between cap 23 and ferrule 66 in pathway 52 after ferrule 66 is introduced into pathway 52.

As discussed above with respect to FIG. 1 and illustrate in FIG. 2A, the portion of pathway 52 defined by main body 50 of cap 23 is configured to engage with an outer surface of ferrule 66, such that ferrule 66 is introduced in one position in pathway 52 relative to main body 50. For example, in the example shown in FIG. 2A, ferrule 66 is relatively centered within pathway 52. As discussed above, this configuration of main body 50 and pathway 52 may be desirable because it may help to align optical fiber 56 with component 20. In other examples, such as examples in which fill material 72 is also positioned between the inner surface of main body 50 and ferrule 66, main body 50 can be configured to receive ferrule 66 in a number of positions within pathway 52, such that the assembler is given some leeway in the relative position of ferrule 66 and main body 50 of cap 23.

In some examples, it may be desirable for cap 23 to be attached to housing 22 in a particular orientation. For example, in some cases, cap 23 may function as a thermo-electric cooler (TEC) that helps dissipate heat generated by optical fiber assembly 16, e.g., in examples in which assembly 16 is used with a relatively high power laser. Thus, in some examples, cap 23 and housing 22 can include one or more features that help to align cap 23 relative to housing 22 in a particular orientation. For example, cap 23 and housing 22 can have complementary geometries and shapes that configure cap 23 to be introduced into housing 22 in one orientation. In the example shown in FIG. 2A, cap 23 and housing 22 have substantially identical beveled or chamfered profiles 76 (e.g., small variations may still be present, but does not affect the extent to which cap 23 and housing 22 can mate together) or identical beveled profiles 76. In other examples, other features can be used to help align cap 23 relative to housing 22 in a particular orientation. For example, graphical or textual markers on housing 22 and cap 23 can be used to indicate the orientation of cap 23 that results in proper alignment of housing 22 and cap 23. During assembly of optical device 14, when an assembler introduces cap 23 into housing 22 such that the graphical or textual markers are aligned, cap 23 may be introduced into housing 22 in the proper orientation.

FIG. 2B is a schematic cross-sectional side view of cap 23 assembled with housing 22. The cross-section is taken through a center of cap 23 and housing 22 and in the x-z plane. Strain relief member 68 is not shown in FIG. 2B, such that ferrule 66 within pathway 52 defined by cap 23 is visible. As shown in FIG. 2B, neck portion 48 of cap 23 includes flange 74, which can extend around the entire outer perimeter of neck portion 48 or just a part of the outer perimeter. Flange 74 is configured to engage with strain relief member 68 and hold strain relief member 68 substantially in place relative to ferrule 66. For example, an inner surface of strain relief member 68 (e.g., the surface facing fiber 56 when strain relief member 68 is disposed around fiber 56) may define a channel that is configured to receive flange 74. Strain relief member 68 can be moved along fiber 56 towards ferrule 66 until flange 74 is received in the channel, such that strain relief member 68 “snaps” into place and substantially holds strain relief member 68 in place until a force sufficient to disengage flange 74 from the channel is applied to strain relief member 68.

FIG. 2C is a schematic end view of housing 22 shown in FIG. 2B and illustrates the opposite end of housing 22 from that shown in FIG. 2A. In the example shown in FIG. 2C, housing 22 includes pins 36C, 36D in addition to pins 36A, 36B shown in FIG. 1. Pins 36C, 36D may be similar to pins 36A, 36B, and may be electrically connected to optical component 20 with the same or different electrical connections as pins 36A, 36D. In addition, pins 36C, 36D may be configured to electrically connect to mounting member 18, e.g., the same or different prongs than pins 36A, 36B. Pins 36A-36D (collectively referred to as “pins 36”) can have any suitable position relative to each other. Although a two-dimensional array of pins 36 is shown in FIG. 2C, in other examples, pins 36 can have any suitable configuration, such as a one-dimensional array (e.g., a single row or column of pins 36) or an irregular configuration (e.g., not aligned in columns and rows, as shown in FIG. 2C).

As with cap 23 and housing 22, mounting member 18 and housing 22 can include one or more interactive features that help align housing 22 in a particular orientation relative to mounting member 18. In the example shown in FIG. 2C, housing 22 has a beveled profile 80, and mounting member 18 (not shown in FIG. 2C) has a substantially identical beveled profile, such that receptacle 28 of housing 22 can only receive plug portion 32 (FIG. 1) of mounting member 18 in one orientation. In other examples, other features can be used to help align housing 22 relative to mounting member 18 in a particular orientation, such as the features described above with respect to housing 22 and cap 23.

FIG. 3 is a schematic exploded cross-sectional side view of housing 22 and cap 23, where the cross-section is taking through a center of housing 22 and cap 23 along the x-z plane. As illustrated in FIG. 3, main body 50 of cap 23 and receptacle 30 of housing 22 are configured such that main body 50 can be introduced into receptacle 30. In the example shown in FIG. 3, when cap 23 is removed from receptacle 30, optical component 20 is exposed (e.g., uncovered) and accessible. As discussed above, this feature may be useful for wire bonding leads 38A, 38B to pins 36A, 36B, respectively, or even removing component 20 to repair component 20 or to replace component 20.

Although optical device 14 described with respect to FIGS. 1-4 is configured to be optically connected to a single optical fiber assembly 56, in other examples, optical device 14 can be configured to receive any one or more optical fiber assemblies. Cap 23 can define any suitable number of pathways 52 that align with a common component or different optical components 20, where each pathway 52 may be configured to receive a respective optical fiber assembly. In these examples, a single ferrule 66 can be used for two or more of the optical fibers, or each optical fiber can be connected to a respective ferrule.

In some examples, housing 22 can be configured to house multiple optical components. For example, one optical component on supporting surface 34 can be an optical receiver and another optical component on support surface 34 can be an optical transmitter (e.g., a light source). As discussed above, the optical components can be optically connected to a common optical fiber and/or different optical fibers. If housing 22 includes multiple optical components, it may, in some examples, be desirable to partition cavity 60 into multiple sub-cavities that are optically isolated from each other. The optical isolation can be achieved by, for example, walls (e.g., oriented to be substantially perpendicular to supporting surface 34) that are optically insulative. In some examples, the sub-cavities are adjacent to each other, and the optical pathways to each sub-cavity are substantially parallel. Two or more optical components can be optically isolated from each other by being placed in respective sub-cavities. The sub-cavity configuration can help reduce optical interference between the different optical components. In addition, or instead, a receptacle 30 may be configured with the micro-optical components to perform the function of an optical circulator, allowing both the transmit and receive signals to be conducted through one fiber.

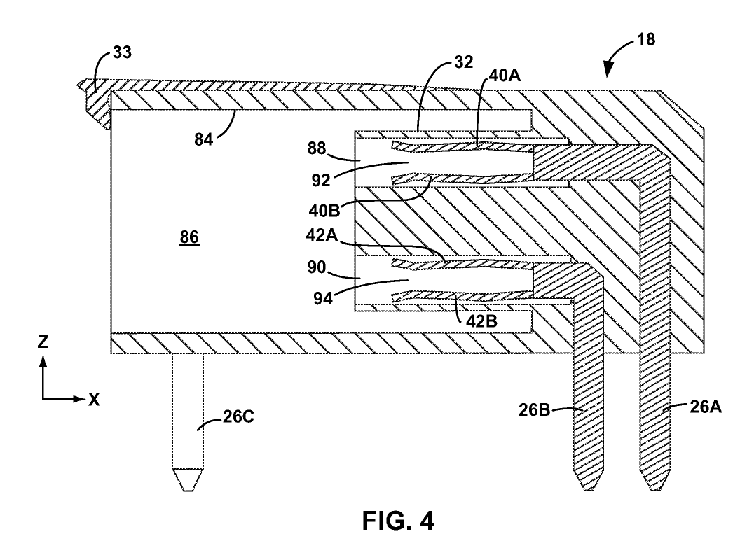

FIG. 4 is a schematic cross-sectional view of mounting member 18, which is configured to mechanically connect to housing 22 and removably electrically and mechanically connect housing 22 to printed board 12. As described above, in some examples, mounting member 18 defines plug portion 32 that is configured to be received in receptacle 28 defined by housing 22 in order to mechanically interconnect housing 22 and mounting member 18. In addition, as shown in FIG. 4, in some examples, inner surface 84 of mounting member 18 define receptacle 86, which is configured to receive housing 22. When housing 22 is introduced in receptacle 86, inner surface 84 of member 18 engages with an outer surface of housing 22. As shown in FIG. 1, receptacle 86 of mounting member 18 is configured to receive the entire housing 22. In other examples, however, housing 22 can protrude from receptacle 86.

As described above with respect to FIG. 1, mounting member 18 includes two sets of electrically conductive prongs 40A, 40B and 42A, 42B that are configured engage with prongs 40A, 40B and 42A, 42B in order to electrically connect optical component 20 to mounting member 18. In the example shown in FIG. 4, each set of prongs 40A, 40B and 42A, 42B is disposed in a respective aperture 88, 90. Apertures 88, 90 are configured to receive pins 36A, 36B of housing 22 and align pins 36A, 36B with the respective set of prongs 40A, 40B and 42A, 42B. Thus, when housing 22 is introduced in receptacle 86 and pins 36A, 36B are introduced into apertures 88, 90, respectively, pins 36A, 36B are positioned between the respective set of prongs 40A, 40B and 42A, 42B, which engage with an outer surface of the pins 36A, 36A.

In some examples, prongs 40A, 40B may define an inner space 92 that, at least at a portion, has a width (measured in the z-axis direction in the example shown in FIG. 4) that is smaller than the outer perimeter of pin 36A. Accordingly, as pin 36A is introduced into aperture 88, pin 36A may push prongs 40A, 40B apart. Because prongs 40A, 40B are biased towards each other, prongs 40A, 40B may engage with an outer surface of pin 36A, thereby making an electrical connection to the conductive pin 36A. Similarly, prongs 42A, 42B may define an inner space 94 that is smaller than the outer perimeter of pin 36b, such that as pin 36b is introduced into aperture 90, pin 36B may push prongs 42A, 42B apart and engage with an outer surface of pin 36A.

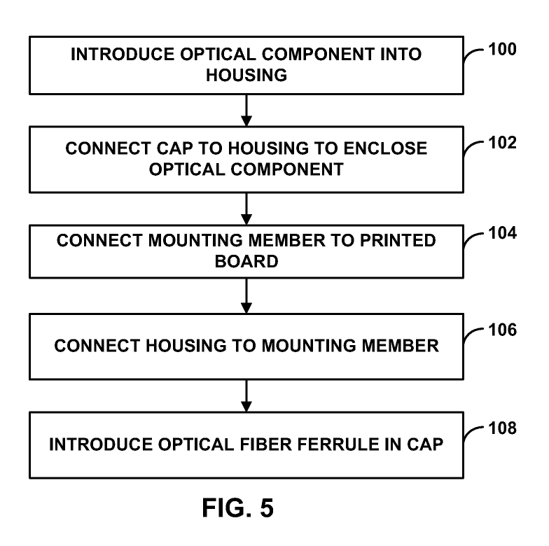

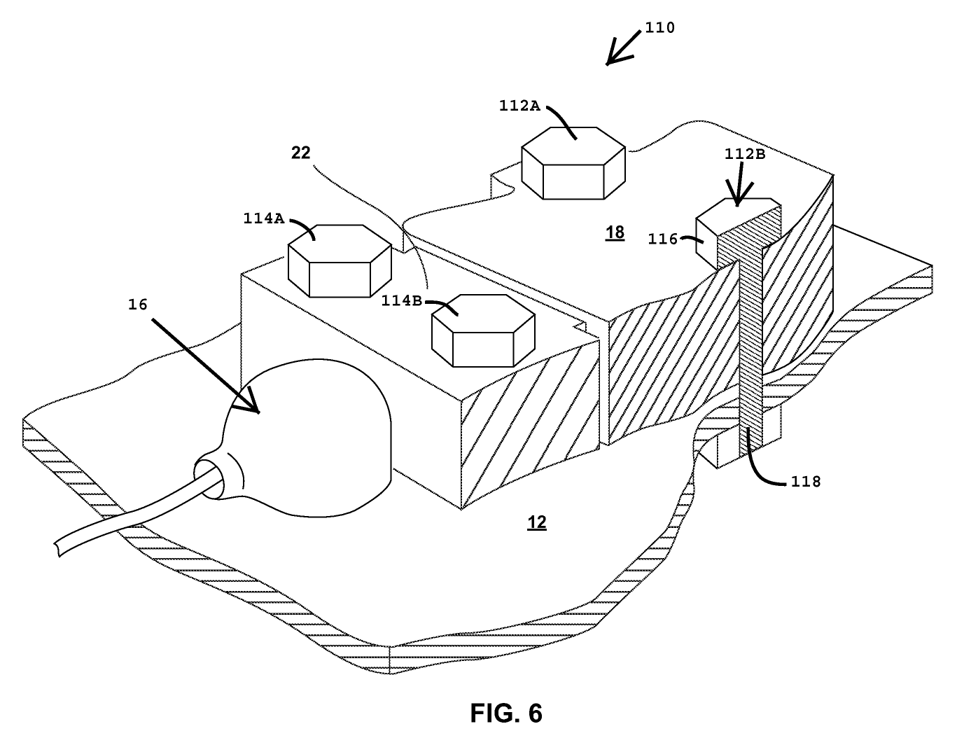

FIG. 5 is a flow diagram illustrating an example technique for assembling printed board assembly 10. While the technique in FIG. 5 is described with respect to assembly 10 shown in FIG. 1, and partially shown in FIG. 2A, FIG. 2B, FIG. 3 and FIG. 4, in other examples, the technique shown in FIG. 5 may be used to assemble other assemblies that include a mounting member that removably connects an optical component to a printed board, where the optical component is enclosed within a housing that is configured to optically connect to an optical fiber.

The technique shown in FIG. 5 includes introducing optical component 20 into housing 22 (100). Optical component 20 can be, for example, introduced into receptacle 30 defined by housing 22 while cap 23 is detached from housing 22. Optical component 20 can be mechanically connected to supporting surface 34 of housing 22 directly or indirectly, e.g., via interface material 21. Attaching optical component 20 to housing 22 may also include electrically connecting optical component 20 to housing 22, e.g., to pins 36A, 36B. Optical component 20 can be electrically connected to pins 36A, 36B using any suitable technique, such as by wire bonding respective electrical contacts of component 20 to pins 36A, 36B, or by aligning the electrical contacts to pins 36A, 36B and soldering or otherwise electrically connecting the electrical contacts to pins 36A, 36B.

The technique shown in FIG. 5 also includes mechanically connecting cap 23 to housing 22 to substantially enclose (e.g., enclose with little to no exposure) or completely enclose optical component 20 in cavity 60 defined by cap 23 and housing 22 (102). Cap 23 can be attached to housing 22 using any suitable technique, such as by introducing main body 50 into receptacle 30.

In some examples, the parts of the technique shown in FIG. 5 that are performed while optical component 20 is still exposed are performed in a clean environment in order to reduce the contaminants to which optical component 20 is exposed. For example, optical component 20 can be introduced into housing 22 (100) and cap 23 can be mechanically connected to housing 22 in a clean environment.

Mounting member 18 can be mechanically connected to printed board 12 (104) by, for example, introducing pins 26 into the respective openings 24 defined by printed board 12. In some examples, an additional securing means is used to secure mounting member 18 to printed board 12. For example, pins 26 can be soldered to the respective openings 24 and/or an adhesive or other bonding material can be positioned between a bottom surface 18A (shown in FIG. 2) of mounting member 18 and printed board 12. Other techniques can also be used to secure mounting member 18 to printed board 12.

Housing 22 can be mechanically connected to mounting member 18 (106). For example, housing 22 can be aligned with mounting member 18 such that plug portion 32 defined by mounting member 18 is introduced in receptacle 28 of housing 22 and housing 22 is introduced in receptacle 86 defined by mounting member 18. In some examples, once mechanically connected, end face 32A of plug portion 32 can contact end face 28A of receptacle 28. In examples in which mounting member 18 includes latching mechanism, after housing 22 is mechanically connected to mounting member 18 (106) and cap 23 is mechanically connected to housing (102), latching mechanism 33 of mounting member 18 may engage cap 23 in order to substantially hold cap 23 and housing 22 in place relative to each other and to mounting member 18.

The technique shown in FIG. 5 also includes introducing optical fiber assembly 16 into cap 23 (108). For example, ferrule 66 can be introduced into pathway 52 defined by cap 52. When ferrule 66 is introduced into pathway 52, optical fiber 16 is aligned with the desired portion of optical component 20. In some examples, it can also be desirable to reduce the contaminants in pathway 52 and on window 54 of cap 23 because contaminants may reduce the power transmitted from optical fiber 16 to optical component 20. Thus, in some examples, ferrule 66 can be installed in pathway 52 of cap 23 in a clean room.

Printed board assembly 10 with a plurality of physically separate parts (printed board 12, mounting member 18, optical component 20, housing 22, and cap 23) that are removably connected to each other provides flexibility during assembly. Thus, the different portions of the technique shown in FIG. 5 can be performed in any suitable order. For example, housing 22 can be mechanically connected to mounting member 18 before or after connecting mounting member 18 to printed board 12. As another example, optical component 20 can be introduced into housing 22 before or after mechanically connecting housing 22 to mounting member 18. In addition, in some examples, optical fiber assembly 16 can be connected to cap 23 prior to connecting cap 23 to housing 22 or prior to connecting mounting member 18 to printed board 12. Other variations in the order of the technique shown in FIG. 5, as well as the steps performed are contemplated.

In some examples, after assembly 10 is assembled, e.g., using the technique shown in FIG. 5, assembly 10 can be at least partially disassembled. For example, cap 23 can be removed from housing 22 by disengaging latching mechanism 33 from cap 23 and pulling cap 23 away from housing 22. In some examples, if seal 62 is positioned between cap 23 and housing 22, the force applied to cap 23 may also break seal 62. In other examples, a solvent or the like can be used to break seal 62. When cap 23 is removed from housing 22, optical component 20 is exposed and accessible. Cap 23 can be removed from housing 22 while optical fiber assembly 16 is still mechanically connected to cap 23, or after optical fiber assembly 16 is disconnected from cap 23. As another example of how assembly 10 can be at least partially disassembled, optical fiber assembly 16 can be removed from cap 23 in order to, for example, replace optical fiber assembly 16 or check window 54.

In addition or instead, assembly 10 can be at least partially disassembled by removing housing 22 from mounting member 18 in order to, for example, replace optical fiber assembly 16 and/or optical component 20 in a clean room or otherwise away from printed board 12. If cap 23 and optical fiber assembly 16 are connected to housing 22, cap 23 and optical fiber assembly 16 are also disconnected from mounting member 18 when housing 22 is disconnected from mounting member 18. Because optical device 14 is configured such that mounting member 18 can remain mechanically and electrically connected to printed board 12 even while housing 22, cap 23 and optical fiber assembly 16 are disconnected from mounting member 18, housing 22 (or a new housing) can be reconnected to mounting member 18 with little to no effect on the connection between mounting member 18 and printed board 12. In this way, optical device 14 may be modified easier than an optical device in which a single housing including an optical component is soldered or otherwise mounted to printed board 12 in a manner that makes it difficult to remove the optical device from printed board 12 without affecting the integrity of the printed board and/or optical device.

As discussed above, in some examples, mounting member 18 and/or housing 22 can be mechanically connected and secured to printed board 12 via one or more through-hole bolts. FIG. 6 is a conceptual perspective view of an example assembly 110 in which mounting member 18 is mechanically connected and secured to printed board 12 via through-hole bolt assemblies 112A, 112B, and housing 22 is mechanically connected and secured to printed board 12 via through-hole bolt assemblies 114A, 114B. Housing 22 can, for example, be bolted to printed board 12 via bolt assemblies 114A, 114B after housing 22 is mechanically connected to mounting member 18. In addition, in examples in which mounting member 18 mounts to printed board 12 using a through-hole technology, mounting member 18 can be secured to printed board 12 via through-hole bolt assemblies 112A, 112B after pins 26A-26C of mounting member 18 are introduced into respective openings 24A-24C in printed board 12. The assembly 110 shown in FIG. 6, however, can also be used in examples in which mounting member 18 mounts to printed board 12 via a surface mount technology. Electrical contacts on an underside 115 of mounting member 18 can, for example, electrically contact (e.g., directly contact or indirectly contact via an interface material) respective electrical contacts on printed board 12 in order to establish an electrical connection between optical component 20 and printed board 12. In the surface mount technology example, mounting member 18 may not include pins 26A-26C and printed board 12 may not include openings 24A-24C.

As the cutaway of printed board 12 shows, bolt assembly 112B includes bolt 118 that extends all the way through a thickness of mounting member 18 (measured in the z-axis direction) and printed board 12. Nut 116 on one side of bolt 116 secures bolt 118 through mounting member 18 and printed board 12, and, therefore, also holds mounting member 18 and printed board 12 in fixed positions relative to each other. Bolt assemblies 112A, 114A, 114B can have configurations similar to that of bolt assembly 112B in some examples.

Bolt assemblies 112A, 112B extend through mounting member 18 in a location that does not interfere with (e.g., extend through) receptacle 86, pins 26A, 26B (if present), or any other components of mounting member 18 that define an electrical pathway through mounting member 18. For example, bolt assemblies 112A, 112B can extend through mounting member 18 such that bolt assemblies 112A, 112B do not contact prongs 40A, 40B, 42A, 42B or pins 26A, 26B.

In some examples, bolt assemblies 114A, 114B extend through housing 22 at a location that does not interfere (e.g., does not extend through) with receptacles 28, 30. This may help reduce the disruption of optical or electrical signals through housing 22, as well as help reduce the possibility of adversely affecting the hermiticity of receptacle 30 in which optical component 20 is mounted. For example, bolt assemblies 114A, 114B can extend through housing 22 such that bolt assemblies 114A, 114B do not contact pins 36A, 36B in receptacle 28.

Various examples have been described. These and other examples are within the scope of the following claims.

1. An assembly comprising:
a housing defining a receptacle;
an optical component within the receptacle of the housing;
a cap configured to mechanically connect to the housing and substantially enclose the optical component in the receptacle;
a mounting member configured to be mechanically connected to a printed board, wherein the mounting member is configured to removably mechanically connect to the housing and electrically connect the optical component to the printed board; and
a plurality of electrical components, wherein the plurality of electrical components and optical component are part of a common optical device, and wherein the electrical components are not enclosed within the housing.

2. The assembly of claim 1, wherein the optical component consists essentially of an optical application specific integrated circuit.

3. The assembly of claim 1, wherein the cap is configured to be introduced in the receptacle of the housing.

4. The assembly of claim 1, wherein the cap comprises an optically transparent window that is optically connected to the optical component when the cap is mechanically connected to the housing.

5. The assembly of claim 1, wherein the cap and housing are configured to define a near-hermetic cavity or hermetic cavity in which the optical component resides.

6. The assembly of claim 1, further comprising an optical fiber assembly, wherein the cap defines a pathway configured to receive the optical fiber assembly and optically connect the optical fiber assembly to the optical component.

7. The assembly of claim 6, wherein the optical fiber assembly comprises an optical fiber that terminates in a ferrule, and wherein the pathway is configured to receive the ferrule and optically connect the optical fiber to the optical component.

8. The assembly of claim 1, wherein prior to mechanical connection of the cap to the housing, the optical component is accessible in the receptacle.

9. The assembly of claim 1, wherein the housing comprises an electrically conductive pin configured to be electrically connected to the optical component, and the mounting member comprises an electrically conductive prong, wherein when the housing is mechanically connected to the mounting member, the pin is electrically connected to the prong.

10. The assembly of claim 1, further comprising the printed board, wherein all of the plurality of electrical components of the optical device are mounted on the printed board and are separate from the housing.

11. The assembly of claim 1, wherein the mounting member comprises a latching mechanism that removably connects the housing and cap to the mounting member.

12. An assembly comprising:
means for housing an optical component of an optical device, wherein the means for housing the optical component does not house electrical components of the optical device;
means for substantially enclosing the optical component in the means for housing, wherein the means for substantially enclosing is physically separate from the means for housing and configured to mechanically connect to the means for housing; and
means for mounting the housing to a printed board, wherein the means for mounting is configured to be removably connected to the means for housing and electrically connect the optical component to the printed board.

13. The assembly of claim 12, wherein the means for housing and the means for substantially enclosing are configured to define a near-hermetic or hermetic cavity in which the optical component resides.

14. A method comprising:
mechanically connecting a cap to a housing to substantially enclose an optical component of an optical device in a receptacle defined by the housing, wherein the receptacle is substantially devoid of any electrical components of the optical device; and
mechanically connecting the housing to a mounting member, wherein the mounting member is configured to removably mechanically connect to the housing and electrically connect the optical component to the printed board.

15. The method of claim 14, further comprising, prior to mechanically connecting the cap to the housing, introducing the optical component into the receptacle defined by the housing.

16. The method of claim 14, further comprising mechanically connecting the mounting member to a printed board.

17. The method of claim 14, further comprising mechanically disconnecting the housing from the mounting member while the mounting member is mechanically and electrically connected to the printed board.

18. The method of claim 14, further comprising introducing an optical fiber assembly into the cap.

19. The method of claim 14, further comprising, removing the cap from the housing to expose the optical component.

20. The method of claim 18, further comprising, removing the optical component from the housing and reconnecting the cap to the housing.
